(19) United States
(12) Patent Application Publication
(10) Pub. No.: US 2024/0214863 A1
(43) Pub. Date: Jun. 27, 2024

(54) RECOMMENDED BIT RATE (RBR) QUERY FOR CODEC MODE REQUEST (CMR)-BASED BIT RATE CHANGE

(71) Applicant: QUALCOMM Incorporated, San Diego, CA (US)

(72) Inventors: Tarun GUPTA, Hyderabad (IN); Rajan KUMAR, Hyderabad (IN); Hemanth Kumar MASARAPU, Hyderabad (IN); Pankaj BANSAL, Hyderabad (IN); Jitender Reddy ANUGU, Hyderabad (IN)

(21) Appl. No.: 18/087,622

(22) Filed: Dec. 22, 2022

(51) Int. Cl. H04W 28/02

(52) U.S. Cl. CPC H04W 28/0257; H04W 28/0268

(57) ABSTRACT

A method for wireless communication by a first user equipment (UE) includes receiving, from a second UE, a codec mode request (CMR) for a new bit rate. The method also includes transmitting, to a network device, a recommended bit rate (RBR) query in response to the new bit rate exceeding a current bit rate. The method still further includes communicating with the second UE using the new bit rate or the current bit rate. A method of wireless communication by a network device includes transmitting, to an originating UE, an RBR for a new bit rate. The method also includes receiving, from a terminating UE, an RBR query in response to the new bit rate exceeding a current bit rate. The method further includes transmitting, to the terminating UE, a response to the RBR query.

### FIELD OF THE DISCLOSURE

The present disclosure relates generally to wireless communications, and more specifically to techniques for recommended bit rate (RBR) querying for codec mode request (CMR)-based bit rate changes.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IOT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In aspects of the present disclosure, a method for wireless communication by a first user equipment (UE) includes receiving, from a second UE, a codec mode request (CMR) for a new bit rate. The method also includes transmitting, to a network device, a recommended bit rate (RBR) query in response to the new bit rate exceeding a current bit rate. The method further includes communicating with the second UE using the new bit rate or the current bit rate.

In other aspects of the present disclosure, a method of wireless communication by a network device includes transmitting, to an originating user equipment (UE), a recommended bit rate (RBR) for a new bit rate. The method also includes receiving, from a terminating UE, an RBR query in response to the new bit rate exceeding a current bit rate. The method further includes transmitting, to the terminating UE, a response to the RBR query.

Other aspects of the present disclosure are directed to an apparatus. The apparatus has a memory and one or more processors coupled to the memory. The processor(s) is configured to receive, from a second UE, a codec mode request (CMR) for a new bit rate. The processor(s) is also configured to transmit, to a network device, a recommended bit rate (RBR) query in response to the new bit rate exceeding a current bit rate. The processor(s) is further configured to communicate with the second UE using the new bit rate or the current bit rate.

Other aspects of the present disclosure are directed to an apparatus. The apparatus includes means for receiving, from a second UE, a codec mode request (CMR) for a new bit rate. The apparatus also includes means for transmitting, to a network device, a recommended bit rate (RBR) query in response to the new bit rate exceeding a current bit rate. The apparatus further includes means for communicating with the second UE using the new bit rate or the current bit rate.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIGS. 4A and 4B are call flow diagrams illustrating a bit rate recommendation and a bit rate recommendation query, respectively, in accordance with aspects of the present disclosure.

FIG. 5 is a call flow diagram illustrating a procedure for recommended bit rate (RBR) adaptation, in accordance with aspects of the present disclosure.

FIG. 6 is a diagram illustrating pseudocode for bit rate adaptation, in accordance with aspects of the present disclosure.

FIG. 7 is a flow diagram illustrating bit rate adaptation, in accordance with aspects of the present disclosure.

FIG. 8 is a call flow diagram illustrating bit rate adaptation, in accordance with aspects of the present disclosure.

FIG. 9 is a flow diagram illustrating an example process performed, for example, by a user equipment (UE), in accordance with various aspects of the present disclosure.

FIG. 10 is a flow diagram illustrating an example process performed, for example, by a network device, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

Radio access network (RAN) assisted codec adaptation is a feature for voice and video enhancement over long term evolution (LTE) or new radio (NR). Using RAN assisted codec adaptation, the RAN may provide a recommended bit rate, or physical layer bit rate, for each logical channel and for each direction (downlink and uplink), when network radio link conditions temporarily change. The RAN provides the recommendation to user equipment (UEs) capable of making use of the recommended bit rate. A UE may use the RAN recommended bit rate, combined with other triggers, to adapt the sending or receiving media bit rate for the logical channel in the direction to which the recommended bit rate relates. If the UE attempts to increase the bit rate in a particular direction beyond the previously received recommended bit rate, the UE may send a recommended bit rate query to the RAN.

A call may be established as a voice over NR (VoNR) call with enhanced voice services (EVS), for example, between a mobile originating (MO) UE and a mobile terminating (MT) UE. During the call, the MO UE may receive a recommended audio downlink bit rate message suggesting a new bit rate. In response, the MO UE sends a message to the MT UE with a codec mode request (CMR) for the new bit rate. The MO UE and MT UE then communicate in accordance with the new bit rate.

The MT UE always honors a bit rate that the MO UE suggests with a CMR. This bit rate, however, may not be efficient from a resource optimization point of view. Currently, the MT UE does not initiate a recommended bit rate (RBR) query, and thus, the RAN does not have visibility into the change in bit rate occurring between the MO UE and the MT UE. As a result, the network adheres to what codec the UEs are using rather than the RAN recommending, to the MT UE, to use a certain bit rate based on channel conditions, cell load, or other parameters.

According to aspects of the present disclosure, an MT UE triggers an RBR query when the MT UE has received a CMR for a higher bit rate than a current bit rate. The network may respond by granting the request or requesting the MT UE to use the current bit rate. Based on the network response, the MT UE can adhere to the latest bit rate or else continue to use the current bit rate. If there is no response from the network, the UE uses the current bit rate. If the CMR bit rate is less than the current bit rate, the UE continues to use the current bit rate. Initiating an RBR query from an MT UE for a specific number of CMRs received within a specified time interval, where the CMR bit rate is greater than the current bit rate, informs the RAN about changes in bit rate. As a result, the network can optimize resource allocation.

Particular aspects of the subject matter described in this disclosure can be implemented to realize one or more of the following potential advantages. In some examples, the described techniques, such as receiving a codec mode request (CMR) and transmitting a recommended bit rate (RBR) query, may provide the radio access network (RAN) with a full view of any bit rate a UE is attempting to modify, helping with resource optimization from the network. For example, the network can take a call (based on the network load in terms of Radio Resources grant), whether to provide UE with the higher bit rate (higher payload), or suggest to use a different lower bit rate (lower pay load) to handle multiple UEs so that call can be sustained for all UEs. Other advantages include a smooth transition in bit rate changes as the RAN allows bit rate changes based on the network resource utilization. As a result, the overall user experience is improved due to better voice quality and proper synchronization between the UE and the RAN.

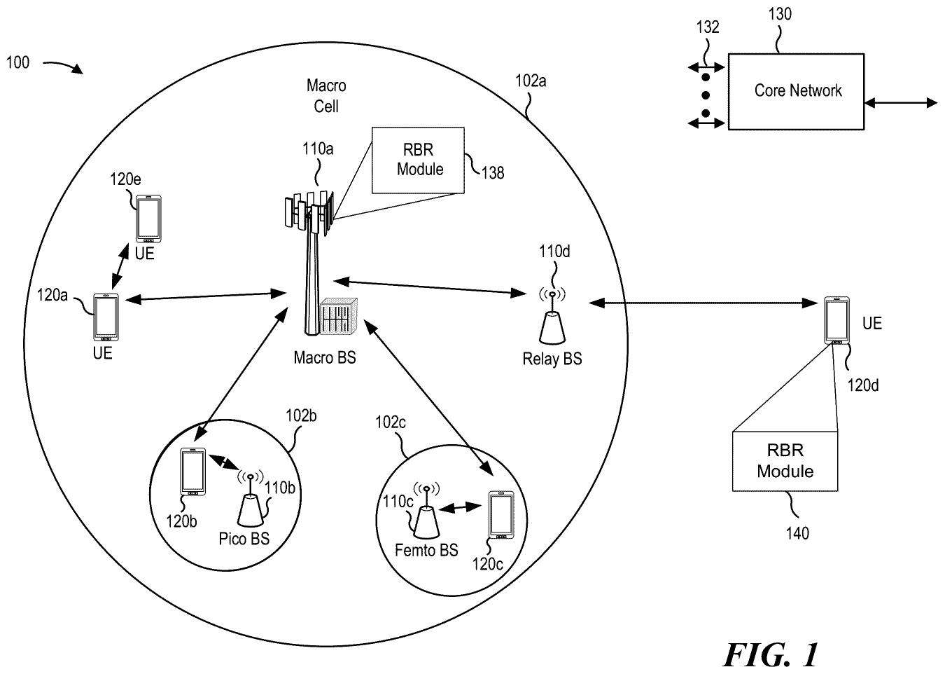

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

The UEs 120 may include a recommended bit rate (RBR) module 140. For brevity, only one UE 120d is shown as including the RBR module 140. The RBR module 140 may receive, from a second UE, a codec mode request (CMR) for a new bit rate. The RBR module 140 may also transmit, to a network device, a recommended bit rate (RBR) query in response to the new bit rate exceeding a current bit rate. The RBR module 140 may further communicate with the second UE using the new bit rate or the current bit rate.

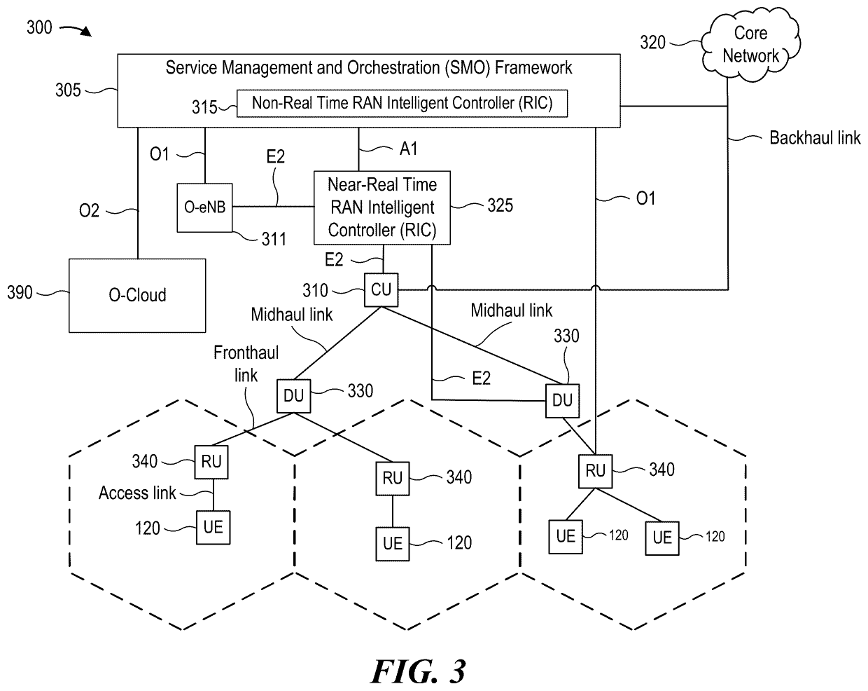

The core network 130 or the base stations 110 or any other network device (e.g., as seen in FIG. 3) may include a recommended bit rate (RBR) module 138. For brevity, only one base station 110a is shown as including the RBR module 138. The RBR module 138 may transmit, to an originating UE, an RBR for a new bit rate. The RBR module 138 may also receive, from a terminating UE, an RBR query in response to the new bit rate exceeding a current bit rate. The RBR module 138 may further transmit, to the terminating UE, a response to the RBR query.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IOT) devices, and/or may be implemented as NB-IOT (narrow band internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

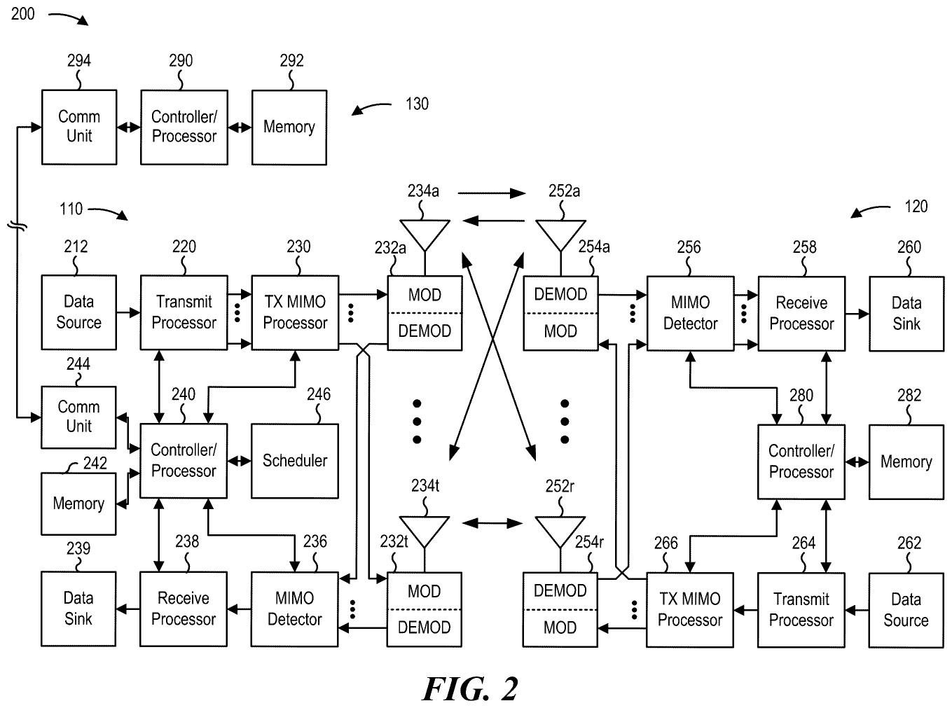

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

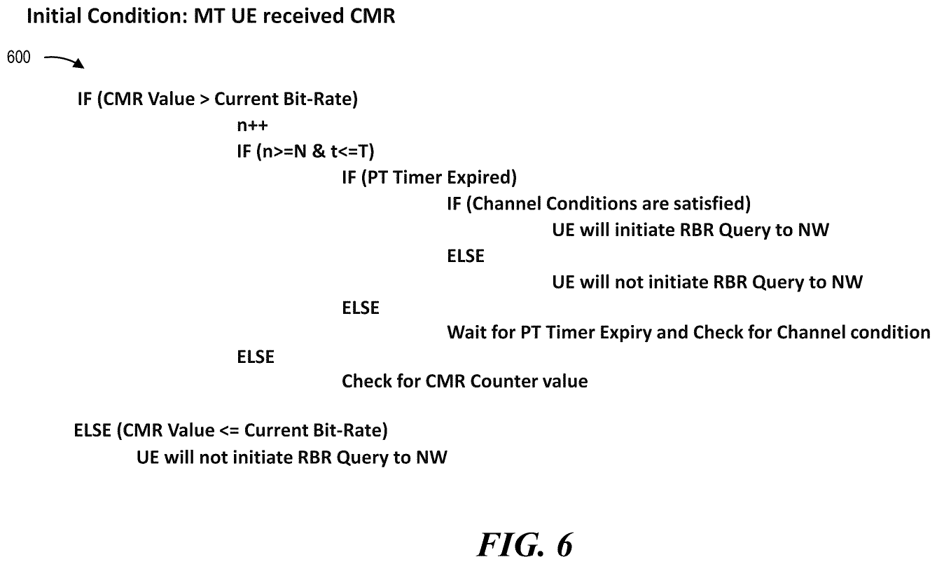

The controller/processor 240 of the base station 110, the controller/processor 280 of the UE 120, and/or any other component(s) of FIG. 2 may perform one or more techniques associated with recommended bit rate adaptation, as described in more detail elsewhere. For example, the controller/processor 240 of the base station 110, the controller/processor 280 of the UE 120, and/or any other component(s) of FIG. 2 may perform or direct operations of, for example, the processes of FIGS. 6-10 and/or other processes as described. Memories 242 and 282 may store data and program codes for the base station 110 and UE 120, respectively. A scheduler 246 may schedule UEs for data transmission on the downlink and/or uplink.

In some aspects, the UE 120 and/or base station 110 may include means for receiving, means for transmitting, means for communicating, and means for using. Such means may include one or more components of the UE 120 or base station 110 described in connection with FIG. 2.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IOT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via 01) or via creation of RAN management policies (such as A1 policies).

Radio access network (RAN) assisted codec adaptation is one of Third Generation Partnership Project (3GPP) Release 14 or Release 15 features for voice and video enhancement over long term evolution (LTE) or new radio (NR). Using RAN assisted codec adaptation, the RAN may provide a recommended bit rate, or physical layer bit rate, for each logical channel and for each direction (downlink and uplink), when network radio link conditions temporarily change. The RAN provides the recommendation to user equipment (UEs) capable of making use of the recommended bit rate. The UE may use the RAN recommended bit rate, combined with other triggers, to adapt the sending or receiving media bit rate for the logical channel in the direction to which the recommended bit rate relates. If the UE attempts to increase the bit rate in a particular direction beyond the previously received recommended bit rate, the UE may send a recommended bit rate query to the RAN.

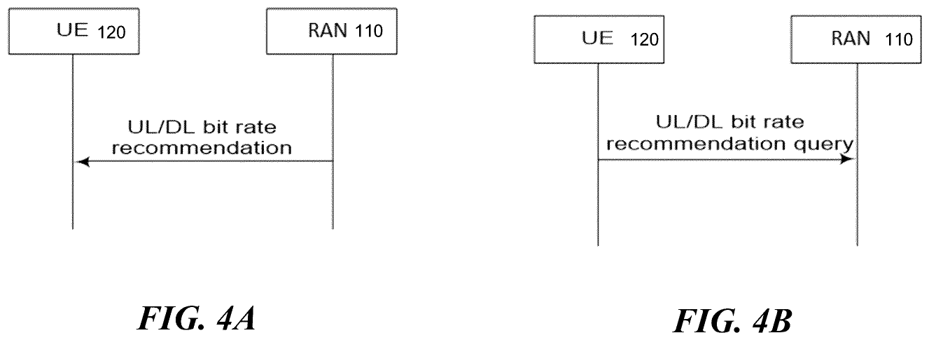

FIGS. 4A and 4B are call flow diagrams illustrating a bit rate recommendation and a bit rate recommendation query, respectively, in accordance with aspects of the present disclosure. In the examples of FIGS. 4A and 4B, a UE 120 communicates with a radio access network (RAN) 110, such as a base station. In FIG. 4A, the RAN 110 transmits an uplink and/or downlink bit rate recommendation to a UE 120. In FIG. 4B, the UE 120 transmits an uplink and/or downlink bit recommendation query to the RAN 110, for example, if the UE 120 attempts to increase the bit rate in a particular direction beyond the previously received recommended bit rate.

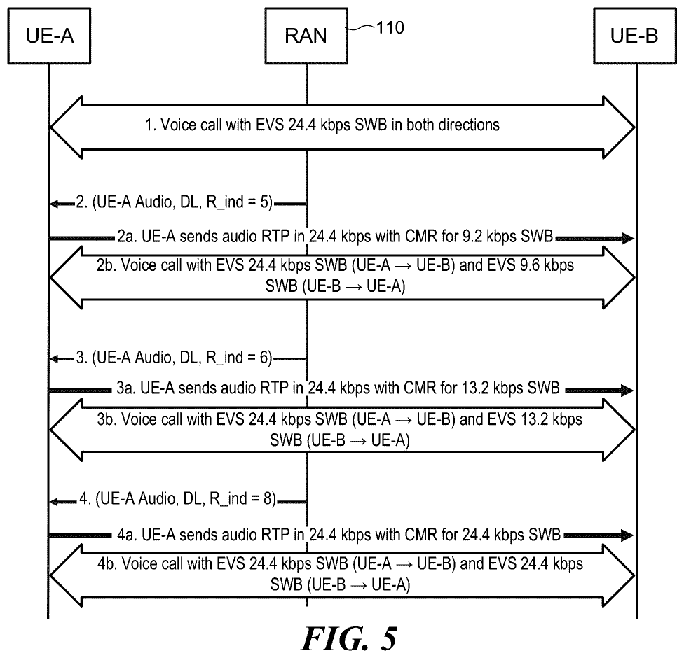

FIG. 5 is a call flow diagram illustrating a procedure for recommended bit rate (RBR) adaptation, in accordance with aspects of the present disclosure. In the example of FIG. 5, a RAN 110 controls communications between a first UE, UE-A, and a second UE, UE-B. Each of the UEs (UE-A, UE-B) is an example of the UE 120 shown in FIG. 1. At time 1, a call is established as a voice over LTE (VOLTE) call with enhanced voice services (EVS) between the first and second UEs, UE-A, UE-B. In the example of FIG. 5, the intended bit rate is 24.4 kbps in both directions at call setup. Although an EVS codec is described, other codecs, such as adaptive multi-rate (AMR) wideband or AMR narrow band are also contemplated.

During the call, at time 2, the first UE, UE-A, receives, from the RAN 110, a recommended audio downlink bit rate message with bit rate index 5, which corresponds to enhanced voice service (EVS) at 9.6 kbps. At time 2a, the first UE, UE-A, immediately sends audio real-time transport protocol (RTP) packets at 24.4 kbps super wideband (SWB) with a codec mode request (CMR) for 9.6 kbps SWB. The first UE, UE-A, also starts a timer T_(aud_ran) and expects to receive audio at 9.6 kbps. At time 2b, the voice traffic from the first UE, UE-A, to the second UE, UE-B, operates in accordance with EVS 24 kbps SWB. The voice traffic from the second UE, UE-B, to the first UE, UE-A, operates in accordance with EVS 9.6 kbps SWB.

Later, at time 3, the first UE, UE-A, receives, from the RAN 110, another recommended audio downlink bit rate message with bit rate index 6, which corresponds to EVS at 13.2 kbps or 16.4 kbps. At time 3a, the first UE, UE-A, immediately sends audio RTP packets at 24.4 kbps SWB with a CMR for 13.2 kbps SWB (or 16.4 kbps SWB (not shown in this example)). The first UE, UE-A, (re-)starts the timer T_(aud_ran). At time 3b, the voice traffic from the first UE, UE-A, to the second UE, UE-B, operates in accordance with EVS 24 kbps SWB. The voice traffic from the second UE, UE-B, to the first UE, UE-A, operates in accordance with EVS 13.2 kbps SWB.

At time 4, the first UE, UE-A, receives, from the RAN 110, another recommended audio downlink bit rate message with bit rate index 8 (or a higher bit rate index), which corresponds to EVS 24.4 kbps. At time 4a, the first UE, UE-A, immediately sends audio RTP packets in 24.4 kbps with a CMR for 24.4 kbps SWB. The first UE, UE-A, also (re-)starts the timer T_(aud_ran). At time 4b, the voice traffic from the first UE, UE-A, to the second UE, UE-B, operates in accordance with EVS 24.4 kbps SWB. The voice traffic from the second UE, UE-B, to the first UE, UE-A, operates in accordance with EVS 24.4 kbps SWB.

In the example of FIG. 5, the mobile termination (MT) UE, UE-B, always honors the bit rate that the far end UE (e.g., first UE, UE-A) is suggesting through CMR. This bit rate, however, may not be efficient from a resource optimization point of view. In the example of FIG. 5, the MT UE, UE-B, is not initiating recommended bit rate (RBR) query, and thus the RAN 110 does not have visibility into the change in bit rate occurring between the mobile originated (MO) UE, UE-A, and the MT UE, UE-B. As a result, the network (e.g., network 100 of FIG. 1) adheres to what codec the UEs are using rather than the RAN 110 recommending the UE, UE-B, to use a certain bit rate based on channel conditions, cell load, or other parameters.

According to aspects of the present disclosure, an MT UE triggers an RBR query when the MT UE has received a CMR for a higher bit rate than a current bit rate. In other words, if the received CMR is larger than a current bit rate, then the MT UE triggers an RBR query to the network. The network may respond by granting the request or requesting the UE to use the current bit rate. Based on the network response, the UE can adhere to the latest bit rate or else continue to use the current bit rate. If there is no response from the network, the UE uses the current bit rate. If the CMR bit rate is less than the current bit rate, the UE continues to use the current bit rate. Initiating an RBR query from an MT UE for a specific number of CMRs within a specified time interval, where the CMR bit rate is greater than the current bit rate, informs the RAN about changes in bit rate. As a result, the network can optimize resource allocation.

FIG. 6 is a diagram illustrating pseudocode 600 for bit rate adaptation, in accordance with aspects of the present disclosure. The pseudocode 600 executes when an MT UE receives a CMR. If the CMR value is greater than a current bit rate, a CMR counter, n, increments and the UE determines if a number, N, of requests have been received within a time, T, for example 200 ms. The parameter T is a time interval for receiving the number, N, of CMRs, and the parameter N is a threshold for the CMR count. This condition prevents overloading of the network with too many requests. If the condition is satisfied, a bit rate query prohibit timer, PT Timer, is checked to ensure CMRs are not sent too frequently. If the PT timer has expired, the UE determines if channel conditions are satisfied, for example, if the channel is good enough to support a higher bit rate. If so, the UE initiates an RBR query to the network.

If the channel conditions are not adequate, the UE does not initiate the RBR query to the network. If the PT Timer has not expired, the UE waits for the PT Timer to expire and again checks the channel conditions after the PT Timer has expired. If the number, N, of requests has not been received within the time, T, the CMR counter value is checked. On the other hand, if the CMR value is less than or equal to the current bit rate, the UE does not initiate an RBR query to the network.

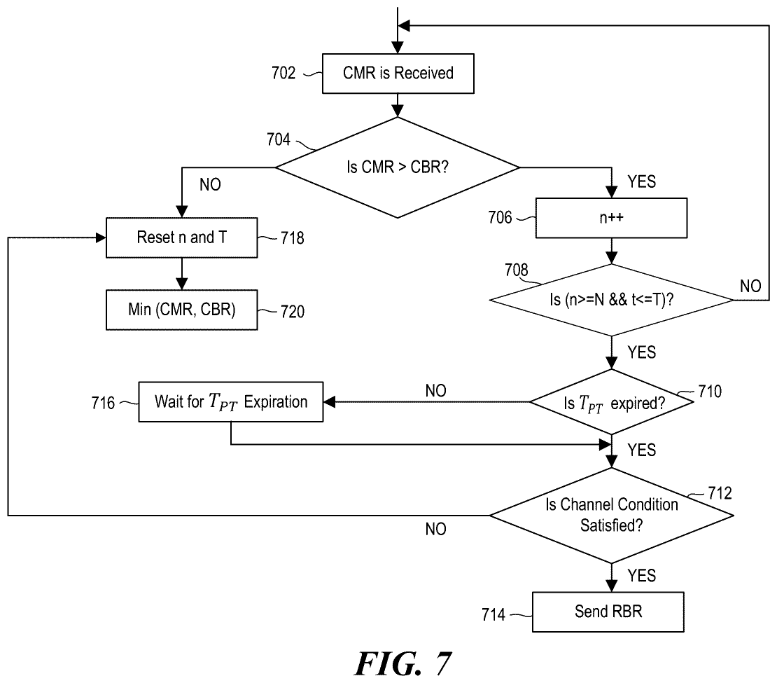

FIG. 7 is a flow diagram illustrating bit rate adaptation, in accordance with aspects of the present disclosure. At block 702, an MT UE receives a codec mode request (CMR). At block 704, it is determined whether the CMR value exceeds a current bit rate (CBR). If so, at block 706, the CMR counter, n, increments. At block 708, it is determined if the number, N, of requests have been received within the time, T, for example 200 ms. If this condition is satisfied, at block 710, the bit rate query prohibit timer, TPT, (also referred to as PT Timer) is checked to ensure RBR queries are not sent too frequently. If the bit rate query prohibit timer, TPT, expired, at block 712, the UE determines if channel conditions are satisfied, for example, if the channel is good enough to support a higher bit rate. If so, the UE initiates an RBR query to the network at block 714.

If the bit rate query prohibit timer, TPT, has not expired (710: NO), at block 716, the UE waits for the bit rate query prohibit timer, TPT, to expire, and after expiration, checks the channel conditions at block 712. If the channel conditions are not adequate (712: NO), the UE does not initiate the RBR query to the network and instead resets the values of the CMR counter, n, and the time, T, at block 718. If the number, N, of requests have NOT been received within the time, T, (708: NO) the process returns to block 702. If the CMR value is less than or equal to the current bit rate (704: NO), the UE does not initiate an RBR query to the network and the process flows to block 718. After resetting the values, at block 718, the MT UE communicates based on a minimum of the current bit rate (CBR) and the CMR value at block 720.

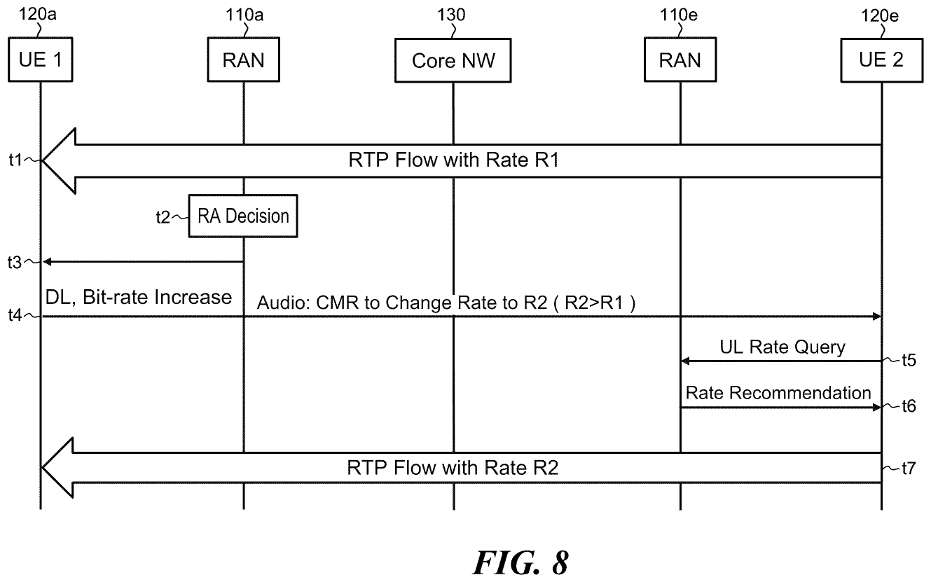

FIG. 8 is a call flow diagram illustrating bit rate adaptation, in accordance with aspects of the present disclosure. In the example of FIG. 8, a first UE, UE 1 120a, and a second UE, UE 2 120-f communicate with each other via a first RAN 110a, a core network 130, and a second RAN 110e. At time t1, the RTP flows from the second UE, UE 2 120e, to the first UE, UE 1 120a, is at a first rate, R1. At time t2, the first RAN 110a, makes a rate adaptation (RA) decision. At time t3, the first RAN 110a transmits a rate recommendation to the first UE, UE 1 120a indicating a downlink (DL) bit rate increase. In response, at time t4, the first UE, UE 1 120a transmits, to the second UE, UE 2 120e, a CMR to change to a second bit rate, R2, that is greater than the first bit rate, R1.

After executing the processes described with respect to FIGS. 6 and 7, at time t5, the second UE, UE 2 120e transmits an uplink rate query (e.g., RBR query) to the second RAN 110e. In response, the second RAN 110e transmits a rate recommendation to the second UE, UE 2 120e, accepting the second rate, R2. As a result, at time t7, the RTP flows from the second UE, UE 2 120e, to the first UE, UE 1 120a, at the second rate, R2.

Aspects of the present disclosure provide the RAN with a full view of any bit rate the UE is attempting to modify, thereby helping with network resource optimization. Other advantages include a smooth transition in bit rate changes as the RAN allows bit rate changes based on the network resource utilization. As a result, the overall user experience is improved due to better voice quality and proper synchronization between the UE and the RAN.

As indicated above, FIGS. 3-8 are provided as examples. Other examples may differ from what is described with respect to FIGS. 3-8.

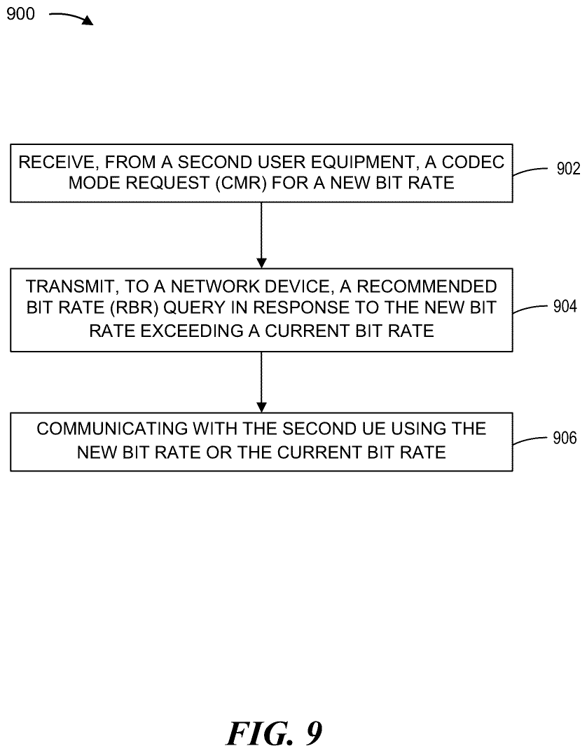

FIG. 9 is a flow diagram illustrating an example process 900 performed, for example, by a user equipment (UE), in accordance with various aspects of the present disclosure. The example process 900 is an example of recommended bit rate (RBR) querying for codec mode request (CMR)-based bit rate changes. The operations of the process 900 may be implemented by a first UE 120.

At block 902, the first user equipment (UE) receives, from a second UE, a codec mode request (CMR) for a new bit rate. For example, the first UE, using (e.g., the antenna 252, DEMOD/MOD 254, MIMO detector 256, receive processor 258, controller/processor 280, memory 282, and/or the like) may receive the CMR.

At block 904, the first UE transmits, to a network device, a recommended bit rate (RBR) query in response to the new bit rate exceeding a current bit rate. For example, the first UE, using (e.g., the antenna 252, DEMOD/MOD 254, TX MIMO processor 266, transmit processor 264, controller/processor 280, memory 282, and/or the like) may transmit the RBR. The first UE may transmit the RBR query immediately when a prohibit timer (PT) timer expires. If the PT timer has not expired then the first UE waits for the PT timer to expire. The first UE may transmit the RBR query in response to a channel condition satisfying a threshold. The first UE may transmit the RBR query in response to a quantity of received CMRs, with a same bit rate, exceeding a threshold quantity of requests within a period of time.

At block 904, the first UE communicates with the second UE using the new bit rate or the current bit rate. For example, the first UE, using (e.g., the antenna 252, DEMOD/MOD 254, MIMO detector 256, receive processor 258, TX MIMO processor 266, transmit processor 264, controller/processor 280, memory 282, and/or the like) may communicate with the second UE. The first UE communicates with the second UE using the new bit rate in response to the network device recommending the new bit rate. The first UE communicates with the second UE using the current bit rate in response to the first UE not receiving, from the network device, a response to transmitting the RBR query, or in response to the network device recommending the current bit rate.

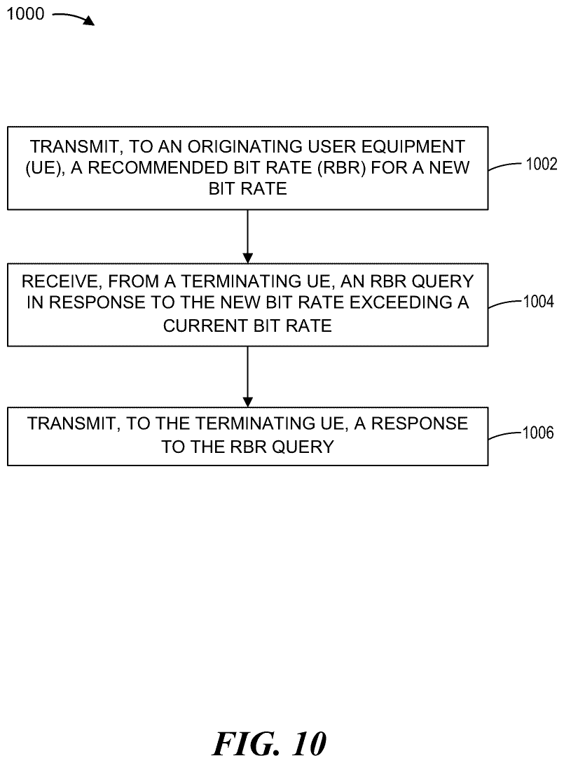

FIG. 10 is a flow diagram illustrating an example process 1000 performed, for example, by a network device, in accordance with various aspects of the present disclosure. The example process 1000 is an example of recommended bit rate (RBR) querying for codec mode request (CMR)-based bit rate changes. The operations of process 1000 may be implemented by a network device, such as a base station 110.

At block 1002, the network device transmits, to an originating user equipment (UE), a recommended bit rate (RBR) for a new bit rate. For example, the network device, using (e.g., the antenna 234, MOD/DEMOD 232, TX MIMO processor 230, transmit processor 220, controller/processor 240, memory 242, and/or the like) may transmit the RBR.

At block 1004, the network device receives, from a terminating UE, an RBR query in response to the new bit rate exceeding a current bit rate. For example, the network device, using (e.g., the antenna 234, MOD/DEMOD 232, MIMO detector 236, receive processor 238, controller/processor 240, memory 242, and/or the like) may receive the RBR.

At block 1006, the network device transmits, to the terminating UE, a response to the RBR query. For example, the network device, using (e.g., the antenna 234, MOD/DEMOD 232, TX MIMO processor 230, transmit processor 220, controller/processor 240, memory 242, and/or the like) may transmit the response. The response may recommend the new bit rate or recommend the current bit rate.

### Example Aspects

Aspect 1: A method of wireless communication by a first user equipment (UE), comprising: receiving, from a second UE, a codec mode request (CMR) for a new bit rate: transmitting, to a network device, a recommended bit rate (RBR) query in response to the new bit rate exceeding a current bit rate; and communicating with the second UE using the new bit rate or the current bit rate.

Aspect 2: The method of Aspect 1, in which the communicating with the second UE comprises using the new bit rate in response to the network device recommending the new bit rate.

Aspect 3: The method of Aspect 1, in which the communicating with the second UE comprises using the current bit rate in response to the first UE not receiving, from the network device, a response to transmitting the RBR query, or in response to the network device recommending the current bit rate.

Aspect 4: The method of any of the preceding Aspects, in which transmitting the RBR query comprises transmitting the RBR query immediately when a prohibit timer (PT) timer expires, or if the PT timer has not expired then waiting for the PT timer to expire.

Aspect 5: The method of any of the preceding Aspects, in which transmitting the RBR query comprises transmitting the RBR query in response to a channel condition satisfying a threshold.

Aspect 6: The method of any of the preceding Aspects, in which transmitting the RBR query comprises transmitting in response to a quantity of received CMRs, with a same bit rate, exceeding a threshold quantity of requests within a period of time.

Aspect 7: A method of wireless communication by a network device, comprising: transmitting, to an originating user equipment (UE), a recommended bit rate (RBR) for a new bit rate: receiving, from a terminating UE, an RBR query in response to the new bit rate exceeding a current bit rate; and transmitting, to the terminating UE, a response to the RBR query.

Aspect 8: The method of Aspect 7, in which the response comprises recommending the new bit rate.

Aspect 9: The method of Aspect 7, in which the response comprises recommending the current bit rate.

Aspect 10: An apparatus for wireless communication by a first user equipment (UE), comprising: a memory: and at least one processor coupled to the memory, the at least one processor configured: to receive, from a second UE, a codec mode request (CMR) for a new bit rate; to transmit, to a network device, a recommended bit rate (RBR) query in response to the new bit rate exceeding a current bit rate: and to communicate with the second UE using the new bit rate or the current bit rate.

Aspect 11: The apparatus of Aspect 10, in which the at least one processor is further configured to use the new bit rate in response to the network device recommending the new bit rate.

Aspect 12: The apparatus of Aspect 10, in which the at least one processor is further configured to use the current bit rate in response to the first UE not receiving, from the network device, a response to transmitting the RBR query, or in response to the network device recommending the current bit rate.

Aspect 13: The apparatus of any of the Aspects 10-12, in which the at least one processor is further configured to transmit the RBR query immediately when a prohibit timer (PT) timer expires, or if the PT timer has not expired then waiting for the PT timer to expire.

Aspect 14: The apparatus of any of the Aspects 10-13, in which the at least one processor is further configured: to transmitting the RBR query comprises transmitting the RBR query in response to a channel condition satisfying a threshold.

Aspect 15: The apparatus of any of the Aspects 10-14, in which the at least one processor is further configured to transmit the RBR query in response to a quantity of received CMRs, with a same bit rate, exceeding a threshold quantity of requests within a period of time.

Aspect 16: An apparatus for wireless communication by a first user equipment (UE), comprising: means for receiving, from a second UE, a codec mode request (CMR) for a new bit rate; means for transmitting, to a network device, a recommended bit rate (RBR) query in response to the new bit rate exceeding a current bit rate: and means for communicating with the second UE using the new bit rate or the current bit rate.

Aspect 17: The apparatus of Aspect 16, in which the means for communicating comprises means for using the new bit rate in response to the network device recommending the new bit rate.

Aspect 18: The apparatus of Aspect 16, in which the means for communicating comprises means for using the current bit rate in response to the first UE not receiving, from the network device, a response to transmitting the RBR query, or in response to the network device recommending the current bit rate.

Aspect 19: The apparatus of any of the Aspects 16-18, in which the means for transmitting the RBR query comprises means for transmitting the RBR query immediately when a prohibit timer (PT) timer expires, or if the PT timer has not expired then waiting for the PT timer to expire.

Aspect 20: The apparatus of any of the Aspects 16-19, in which the means for transmitting the RBR query comprises means for transmitting the RBR query in response to a channel condition satisfying a threshold.

Aspect 21: The apparatus of any of the Aspects 16-20, in which the means for transmitting the RBR query comprises means for transmitting in response to a quantity of received CMRs, with a same bit rate, exceeding a threshold quantity of requests within a period of time.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication by a first user equipment (UE), comprising:
receiving, from a second UE, a codec mode request (CMR) for a new bit rate;
transmitting, to a network device, a recommended bit rate (RBR) query in response to the new bit rate exceeding a current bit rate; and
communicating with the second UE using the new bit rate or the current bit rate.

2. The method of claim 1, in which the communicating with the second UE comprises using the new bit rate in response to the network device recommending the new bit rate.

3. The method of claim 1, in which the communicating with the second UE comprises using the current bit rate in response to the first UE not receiving, from the network device, a response to transmitting the RBR query, or in response to the network device recommending the current bit rate.

4. The method of claim 1, in which transmitting the RBR query comprises transmitting the RBR query immediately when a prohibit timer (PT) timer expires, or if the PT timer has not expired then waiting for the PT timer to expire.

5. The method of claim 1, in which transmitting the RBR query comprises transmitting the RBR query in response to a channel condition satisfying a threshold.

6. The method of claim 1, in which transmitting the RBR query comprises transmitting in response to a quantity of received CMRs, with a same bit rate, exceeding a threshold quantity of requests within a period of time.

7. A method of wireless communication by a network device, comprising:
transmitting, to an originating user equipment (UE), a recommended bit rate (RBR) for a new bit rate;
receiving, from a terminating UE, an RBR query in response to the new bit rate exceeding a current bit rate; and
transmitting, to the terminating UE, a response to the RBR query.

8. The method of claim 7, in which the response comprises recommending the new bit rate.

9. The method of claim 7, in which the response comprises recommending the current bit rate.

10. An apparatus for wireless communication by a first user equipment (UE), comprising:
a memory; and
at least one processor coupled to the memory, the at least one processor configured:
to receive, from a second UE, a codec mode request (CMR) for a new bit rate;
to transmit, to a network device, a recommended bit rate (RBR) query in response to the new bit rate exceeding a current bit rate; and
to communicate with the second UE using the new bit rate or the current bit rate.

11. The apparatus of claim 10, in which the at least one processor is further configured to use the new bit rate in response to the network device recommending the new bit rate.

12. The apparatus of claim 10, in which the at least one processor is further configured to use the current bit rate in response to the first UE not receiving, from the network device, a response to transmitting the RBR query, or in response to the network device recommending the current bit rate.

13. The apparatus of claim 10, in which the at least one processor is further configured to transmit the RBR query immediately when a prohibit timer (PT) timer expires, or if the PT timer has not expired then wait for the PT timer to expire.

14. The apparatus of claim 10, in which the at least one processor is further configured to transmit the RBR query in response to a channel condition satisfying a threshold.

15. The apparatus of claim 10, in which the at least one processor is further configured to transmit the RBR query in response to a quantity of received CMRs, with a same bit rate, exceeding a threshold quantity of requests within a period of time.

16. An apparatus for wireless communication by a first user equipment (UE), comprising:
means for receiving, from a second UE, a codec mode request (CMR) for a new bit rate;
means for transmitting, to a network device, a recommended bit rate (RBR) query in response to the new bit rate exceeding a current bit rate; and
means for communicating with the second UE using the new bit rate or the current bit rate.

17. The apparatus of claim 16, in which the means for communicating with the second UE comprises means for using the new bit rate in response to the network device recommending the new bit rate.

18. The apparatus of claim 16, in which the means for communicating with the second UE comprises means for using the current bit rate in response to the first UE not receiving, from the network device, a response to transmitting the RBR query, or in response to the network device recommending the current bit rate.

19. The apparatus of claim 16, in which the means for transmitting the RBR query comprises means for transmitting the RBR query immediately when a prohibit timer (PT) timer expires, or if the PT timer has not expired then waiting for the PT timer to expire.

20. The apparatus of claim 16, in which the means for transmitting the RBR query comprises means for transmitting the RBR query in response to a channel condition satisfying a threshold.

21. The apparatus of claim 16, in which the means for transmitting the RBR query comprises means for transmitting in response to a quantity of received CMRs, with a same bit rate, exceeding a threshold quantity of requests within a period of time.
